(19) United States
(12) Patent Application Publication
(10) Pub. No.: US 2006/0099566 A1
(43) Pub. Date: May 11, 2006

(54) Designer's choice chalkboard

(76) Inventor: Rhonda Kay Priem, Chanhassen, MN (US)

Correspondence Address: Rhonda Kay Priem, 8647 Flamingo Drive, Chanhassen, MN, 55317, US

(21) Appl. No.: 10/982,836

(22) Filed: Nov. 8, 2004

(51) Int. Cl. B43L 1/00

(52) U.S. Cl. 434/408

(57) ABSTRACT

Designer's Choice Chalkboard can be custom decorated to individual taste or décor. This invention consists of a durable smooth surface board, which can be of varying sizes. Multiple openings, which can be of different shapes and sizes, are cut around the outside edges of the board to form a decorative pattern. A finish is applied to the surface of the board that allows users to write and erase messages from the board surface. The openings around the outside of the board allow decorative ribbons, raffia, leaves, and unlimited other decorating mediums to be weaved through the openings. This allows the board to be custom decorated to individual taste or décor. The board may come with a supply of decorative materials. The board can be used in multiple locations and for multiple purposes. The board can be hung or displayed on a stand.

### CROSS-REFERENCE TO RELATED APPLICATION

This application claims the benefit of U.S. provisional application Ser. No. 60/519,455 filed Nov. 10, 2003, the entire disclosure of which is incorporated herein by reference.

### BACKGROUND OF THE INVENTION

This invention relates to home decor, and more particularly to custom decorated chalkboards.

Many consumers enjoy decorating their homes and incorporating messaging into decorating themes. This invention is directed primarily to consumers for use in creating a way to incorporate messages into their unique decorating themes. In addition, the invention can be used in businesses, studios, and retail establishments, as well as in private homes.

There are many types of chalkboards that have been designed and are used for educational, business and personal use. These chalkboards come in many different sizes and shapes. Some of the chalkboards are designed as message boards and can be hung on walls or other flat surfaces. However, these chalkboards can not be customized for decorating purposes.

In view of the above shortcoming, it would be thus desirable to have a chalkboard that can be customized to fit an unique decorating theme.

### SUMMARY OF THE INVENTION

The Designer's Choice Chalkboard can be custom decorated for individual taste or décor.

The chalkboard can come in different sizes and shapes. The surface of the chalkboard consists of a hard smooth surface that is treated with a substance that allows the user to write and erase messages from the surface. Multiple openings are cut into the chalkboard surface to create a decorative pattern. Users can than weave different types of decorative ribbon, raffia, leaves or any other type of materials through the openings to create a decorative pattern. This allows the chalkboard to be custom decorated to meet the individuals taste or décor. Users can than display messages on the custom decorated chalkboards.

### BRIEF DESCRIPTION OF THE DRAWING

FIG. 1 (#1) is a front plan view of a smooth surface board, which can be of varying sizes, that is covered with a finish that allows users to write and erase messages on the board.

FIG. 2 (#2) is a front plan view of a smooth surface board with multiple openings, which can be of different shapes and sizes, which are cut around the edges of the board to form a decorative pattern.

FIG. 3 (#3) is a front plan view of a smooth surface board with multiple openings, which can be of different shapes and sizes, that are cut around the edges of the board to form a decorative pattern. A decorative medium, which can be of unlimited types, is weaved through the openings. This allows the board to be custom decorated for individual taste and décor.

### DETAILED DESCRIPTION OF THE INVENTION

While the invention is susceptible to various modifications and alternative forms, the specific embodiment(s) shown and/or described herein is by way of example. It should thus be appreciated that there is no intent to limit the invention to the particular form disclosed, as the intention is to cover all modifications, equivalents, and alternatives falling within the spirit and scope of the invention as defined by the appended claims.

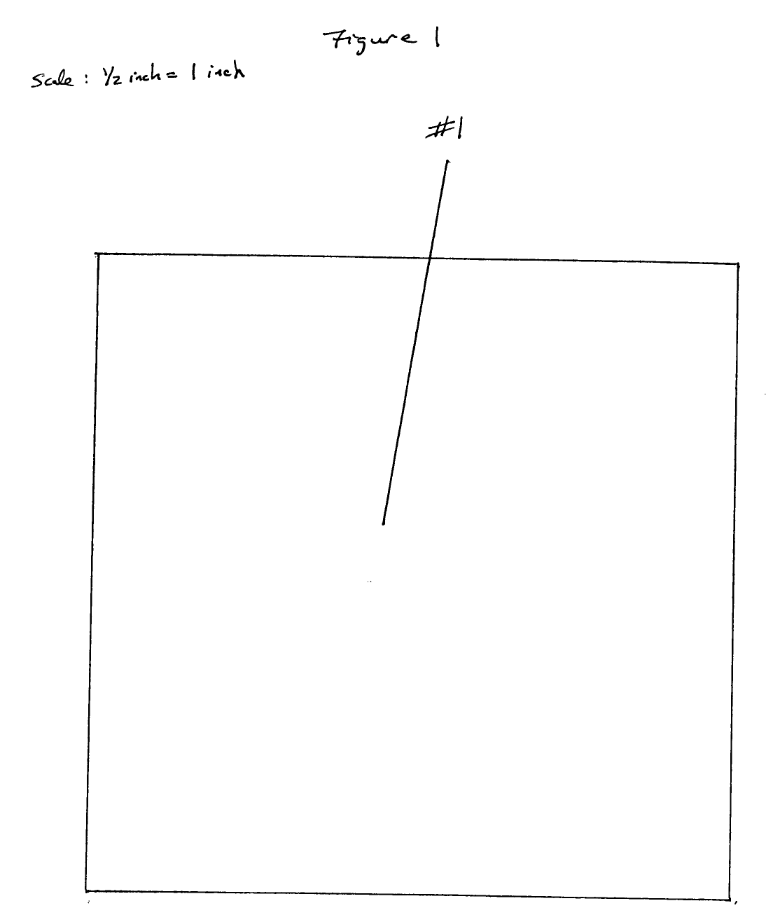

The chalkboard can be created from any hard smooth surfaced material including hardboard, fiberboard, wood or manufactured wood products. In FIG. 1 there is shown an example of a square shaped chalkboard approximately 12 inches by 12 inches in size. However, there is no limitation to the actual shape or size of the chalkboard. Prior to cutting the chalkboard to its desired sized and shape, a finish is applied to the surface which will allow users to write and erase messages. After the finish is properly dried, the chalkboard is cut to the desired size and shape.

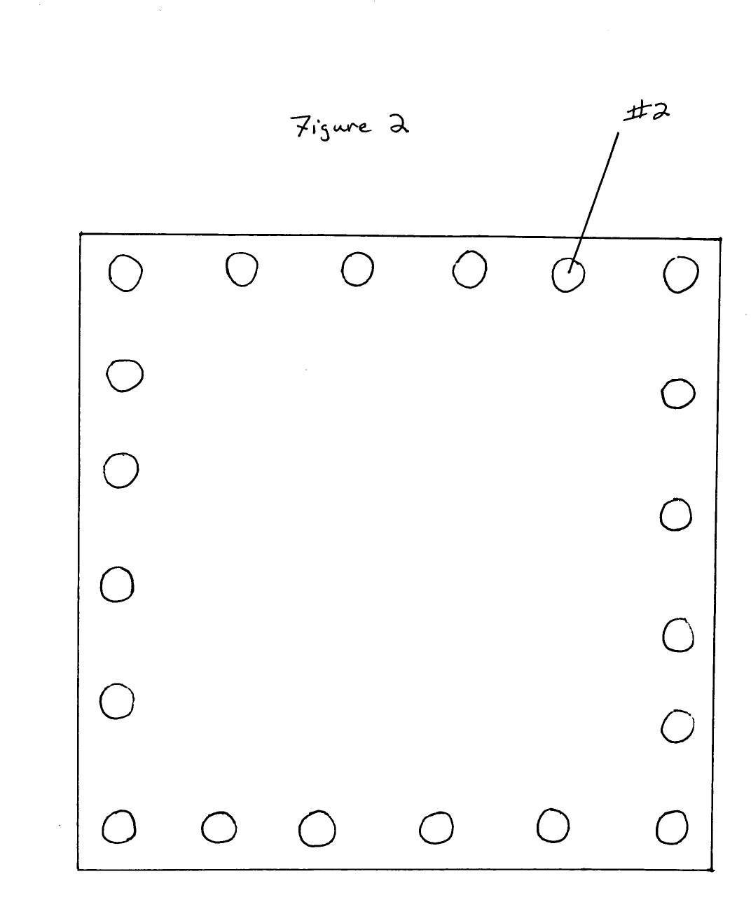

Once the chalkboard is the desired size and shape, multiple openings are cut around the edges of the board. The openings can be created by drilling, punching or other techniques designed to create openings in hard surfaces. In FIG. 2 there is shown an example of a circular opening approximately 1 inch by 1 inch in size. However, there is no limitation to the actual size or shape of the openings. Also, there is no limitation to the number of openings.

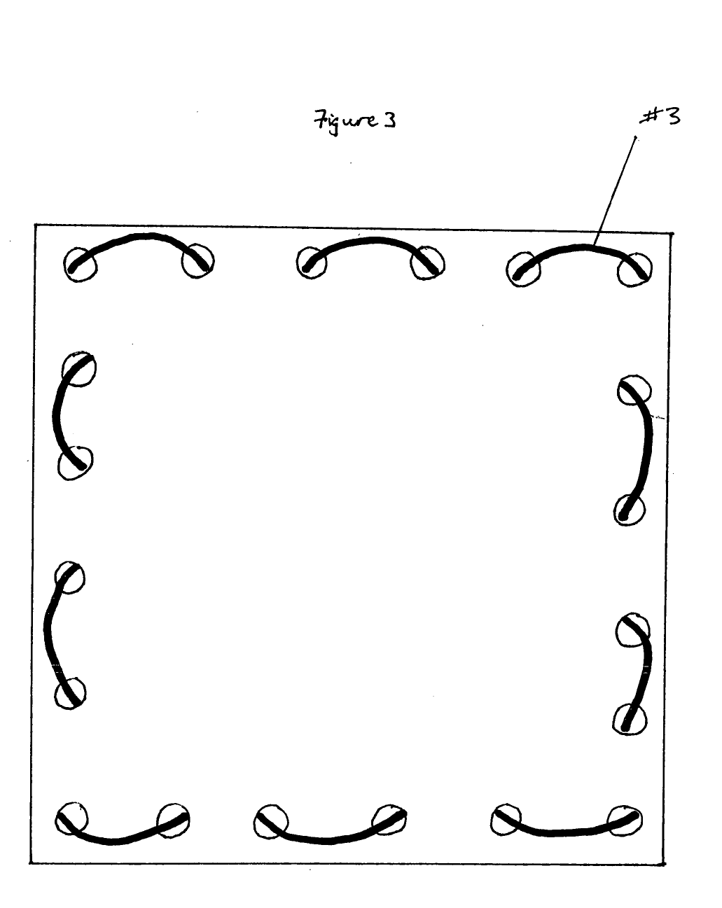

After the desired openings have been created, a decorative medium can be weaved through the openings. In FIG. 3 there is shown an example of a narrow ribbon being woven through the openings. However, there is no limitation to the actual decorative medium that is used.

While this invention has been described as having various preferred designs and/or configurations, the present invention can be further modified within the spirit and scope of this disclosure. This application is therefore intended to cover any variations, uses, or adaptations of the invention using its general principles. Further this application is intended to cover such departures from the present disclosure as come within known or customary practice in the art to which this invention pertains and which fall within the limits of the claims.

What is claimed is:

1. A decorative chalkboard that can be customized for individual taste or décor, said chalkboard consists of a durable smooth surface board and multiple opening of different sizes and shapes cut around the outside edges of the board to form a decorative pattern which can be hung on a hard surface, from a hook or displayed on a stand.

2. A decorative chalkboard as set forth in claim 1 can be of varying sizes and shapes, with a finish applied to the surface that allows users to write and erase messages from the board's surface.

3. A decorative chalkboard as set forth in claim 1 and 2 can be decorated by weaving ribbons, raffia, leaves and unlimited other mediums through the openings located around the outside edges of the board.
